(19) United States
(12) Patent Application Publication
(10) Pub. No.: US 2017/0254507 A1
(43) Pub. Date: Sep. 7, 2017

(54) Method and means for reflecting light to produce soft indirect illumination while avoiding scattering enclosures

(71) Applicant: Sergio Lara Pereira Monteiro, Los Angeles, CA (US)

(72) Inventor: Sergio Lara Pereira Monteiro, Los Angeles, CA (US)

(21) Appl. No.: 15/448,503

(22) Filed: Mar. 2, 2017

Related U.S. Application Data
(60) Provisional application No. 62/302,693, filed on Mar. 2, 2016.
(60) Provisional application No. 62/443,285, filed on Jan. 6, 2017.

(51) Int. Cl. F21V 7/00; F21K 9/68; F21V 17/10; F21V 7/04

(52) U.S. Cl. CPC F21V 7/0008; F21V 7/005; F21V 7/0041; F21V 7/048; F21K 9/68; F21V 17/10; F21Y 2115/10

(57) ABSTRACT

A HubblePerkinElmer correcting mirror for luminaries intended to illuminate a room, where the luminaries may send direct bright light towards directions that are inconvenient. Similarly to its space telescope device, the HubblePerkinElmer correcting mirror redirects the emitted light to other directions that are more advantageous for illumination, particularly to avoid direct bright light onto the eyes of humans in the space.

### CROSS-REFERENCE TO RELATED APPLICATIONS

This application is a utility patent application based on a previously filed U.S. Provisional Patent Application Ser. No. 62/302,693 filed on 2016 Mar. 2, titled “Method and means for isotropic evenly distributed ambient illumination with indirect light and to avoid bright LED beam directly into human eyes”, and Provisional Patent Application Ser. No. 62/443,285, filed on 2017 Jan. 6, titled “Several variations of method and means for isotropic evenly distributed ambient illumination and to avoid bright LED beam directly into human eyes”, all from the same sole inventor, the benefit of which is hereby claimed under 35 U.S.C. par. 119(c) and incorporated herein by reference in its entirety.

### FEDERALLY SPONSORED RESEARCH

Not applicable

### SEQUENCE LISTING OR PROGRAM

Not applicable

### BACKGROUND OF THE INVENTION

Field of Invention

This invention relates to luminaries for indoor domestic, commercial and industrial applications and also for outdoor uses.

Discussion of Prior Art

For better accuracy, and to comply with the USPTO rules, one of which require that the specification be “clear and full” and the use of “exact terms to enable any person skilled in the art or science to which the invention pertains to make and use the same”, we want to first define a few of the terms used in the sequel.

Diffuse reflection: A surface causes diffuse reflection when the scattering of light reaching the surface is statistically distributed over a wide 3-D angle, preferably if no direction of scattering is more favored than other, that is, if the scattering is isotropic. Often diffuse reflectors are characterized by a rough surface with a surface roughness that is very small for the characteristic dimensions of the situation, as small with respect to the diameter (or width) of the light beam reaching the surface. (cf. Specular reflection).

E27 (or E26 in USA): There is no certainty on the meaning an origin of this name, but it appears that this stands for Edison 27 mm screw base luminary used for the old-style incandescent bulbs in the world (or 1 in. in USA, which for some reason the inventor cannot fathom became 26 mm instead of 25 mm, which is the correct approximation to 1 in.). They are mostly interchangeable, because both the male luminary and the female receptacle have so few threads that the small difference does not accumulate enough to stop further turning the bulb in the hole.

Illuminance: In photometry, illuminance is the total luminous flux incident on a surface, per unit area. Note that the illuminance value is adjusted to the detection capability of the human eye, with zero contribution by undetectable wavelengths, as ultra violet and infra red, and smaller contribution per light energy on the red then on the green. Illuminance is a measure of how much the incident light illuminates the surface, wavelength-weighted by the luminosity function to correlate with human brightness perception. Similarly, luminous emittance is the luminous flux per unit area emitted from a surface. Luminous emittance is also known as luminous exitance. (cf. Luminous emittance) (Adapted from wikipedia, on 2015-07-07)

Jumper: an electrical connector that wraps a piece of metal around two wires, therefore completing the electrical connection between the two wires. Jumpers are common in digital electronics, and the most common situation which a non-technical person encounter jumpers is their use to select which is the use of the older PATA hard drives, either master, or slave. In digital electronics the jumpers are used to connect/disconnect a particular point to ground (or to the positive supply, whichever is the voltage for the circuit), therefore making the particular point low (high) in the language of digital electronics, which is then interpreted by digital logic to implement one of two choices (binary choices, including address and/or control).

Luminous emittance: is the luminous flux per unit area emitted from a surface. Luminous emittance is also known as luminous exitance (cf. Illuminance). (From wikipedia, on 2017-02-12)

Specular reflection: The reflection caused by a surface in such a way that the reflection obeys the standard law of mirror reflection that the angle of incidence is equal to the angle of reflection—or some other similar law, or that, in general, an incident light beam that is narrow continues narrow after reflection and that the angular aperture of the beam changes little of nothing after reflection. (cg. Diffuse reflection).

A quick look at some pre-LED light devices, either with the eyes or with the memory, shows that associated with their different characteristics, there comes different physical supports, different electrical characteristics, and even different safety mechanisms. The most used light source in homes was (and still is in USA) the incandescent electric bulb, known as E27 in Europe and most of the world, and known as E26 in USA, a slightly different screw pitch, supposedly one inch, in reality a wrong approximation to millimeter made by American engineers, because 1 in =25.4 mm, which is approximated to 25 not 26. This E27 incandescent bulb produced (produces) a mostly isotropic light emanating from a small volume, which is the filament inside the bulb. The original clear bulb was mostly overtaken by the frosty bulbs that are virtually the only ones seen now, with a frosty or milky enclosure, the function of which is to increase the surface area of the emitting surface—now the full bulb surface, larger than the filament surface, therefore decreasing the luminous emittance, or the energy per unit area of emitter, or brightness in common parlance. The light produced by the incandescent light bulb is too strong to be looked at directly, particularly if it is of the even older clear bulb type but still too bright even if it is the frosty glass enclosure used for so many decades now, that most people do not even know of the clear glass bulb of the fore. It is worth to point out, though, that the incandescent bulbs inside ovens and refrigerators are clear bulbs, the reason being that due to their locations they cannot be looked at directly, so they are possible in ovens and refrigerators, where they are in exclusive use because the frosty bulbs absorb light too, besides scattering the light, so the frosty bulbs produce less light per unit of electrical energy used (they are less efficient). It is worth to point this out here because our invention has to do exactly with the light absorption of the frosty enclosures around luminaries and their substitution by reflecting surfaces, which is the invention disclosed in the sequel, so, the very use of clear bulbs inside refrigerators and ovens is an indication that the problem solved by this invention is an old recognized problem. It is interesting to note that the absorption caused by the frosty enclosing surfaces is a problem known for decades, though one that was never solved, largely because it was not to the interest of the energy producing companies in US. We will describe our main embodiment applied to this E27 incandescent bulb, and/or some varieties of their LED substitutes, then will discuss several variations of the main embodiment applicable for luminaries as the tubular fluorescent.

For businesses and schools, one of the light sources most used is the tubular fluorescent light, which for business purposes was a long tube some 2, 4, or more feet long, which produced also a mostly isotropic light, but from a much larger area, which is the whole surface of the long glass tube. The fluorescent lamps entered in general use since the late 30s and mostly after World War II (WW II), when the United States, as the only surviving nation with its industrial capacity intact, was technologically an advanced country, which is the reason for them to be measured in feet (English units), the same reason that the LPs are manufactured and known in inches, while the CDs, which were introduced in 1982 by Philips and Sony, a Dutch-Japanese consortium, when the Unites States were already in decline, is measured in mm (120 mm for the standard music CD).

As a consequence of the above, the incandescent light bulb typically has some or several devices to smooth the light distribution, while the long fluorescent lamps do not need them as much. Such characteristics turn out to be important for our invention, because our invention is a correction to both the old luminaries of the past (E27 incandescents, tubular fluorescents, etc.) and to some of the implementation of the LED light sources that have been introduced to replace the old, less efficient sources. Besides the application to the new LED-substitutes for the old incandescents E27, old tubular fluorescents, etc., as it will be clear with the description of our invention, our invention also applies to the current devices, that is, to the E27 incandescent light bulbs, to the fluorescent tubes, and other old-style luminaries. Some of the physical characteristics of the new LED replacements need to stay the same, insofar they are part of the necessary characteristics to make the LED replacement compatible with the old standard, but not all characteristics of the LED substitutes have to be the same, particularly the directionality of the emitted light.

Repeating and resuming the above, some of the former luminaries being now replaced by more energy efficient LEDs are too bright to be looked at directly. This is the reason for the frosty enclosures that surround many of the old luminaries, the most offending one being the E27 incandescent lamps.

Our invention is to solve the problem created by the frosty enclosures, which were created to scatter the light emitted inside them, but which by necessity also absorbs light, which is a cause of energy inefficiency, as a consequence of the photons lost to absorption as they propagate through the frosty material designed to scatter them (25% or more absorption). In anticipation, our invention may be used both with the legacy luminaries, as the E27 incandescent bulbs, the tubular fluorescents, etc., and with some of their LED replacements as well. Our invention makes the frosty enclosures redundant, using instead mirrors so positioned and located as to reflect the light from the too bright sources, away from the eyes of the people in the room, to the upper walls and to the ceilings of the rooms, from where the light is isotropically reflected again by surfaces of high reflectivity: the walls and the ceiling. Given that the reflectivity of a mirror at glazing incidence is close to 100%, and that the reflectivity of most wall and ceiling paints are around 90%, it follows that the device of our invention offers a better energy efficiency when compared with the old devices: 10% loss for our invention versus 25% loss for the former devices. The surfaces onto which the initial light energy is reflected is preferentially the ceilings and upper part of the walls, but occasionally there may be other surfaces, on a particular room or type of rooms, which is neither a ceiling nor an upper part of a wall; such cases are considered to be included in our invention, which is the energy savings with the elimination of the frosted enclosures, and the more even illumination from a larger surface area of the walls and ceilings, as compared with the illumination originating mostly from a smaller area of the frosted enclosure.

Our invention, as will be seen later, is a set of mirrors, at locations and directions designed to correct the direction of propagation of the light away from people's eyes to the most desired places, as, for example, high walls and ceilings, reminisces the correcting mirrors added to the Hubble Space Telescope, which were inserted in the telescope to also correct a wrong prior device, the incorrectly polished Space Telescope main mirror. The Hubble main mirror was polished by the high-tech American company Perkin-Elmer at its state-of-the-art facility in Connecticut, so we call our invention the Hubble-Perkin-Elmer correcting mirror. Our invention is adapted for use with both the old-style luminaries and their new LED substitutes as well.

### Introduction to the Problem and its Solution

The problem we propose to solve with this invention stems from enclosing the bright luminary in a glass/plastic or other semi-transparent material with a larger surface area, which in turn decreases the luminous emittance (that is, in laymen's words, the light energy per unit area, or brightness). The problem is that the encasing container also absorbs light, which causes loss of money from the owner's pocket. Given that money is such a paramount concept in American mentality, working within American capitalism, this source of loss should be avoided. Our solution to this problem of light and money loss caused by the containing enclosure, is simply making the container superfluous. On the other hand since the bright light source ought not to blind the people in the room, it follows that the solution is to redirect all the light emitted by the luminaries along such directions that it propagates to diffuse reflectors, so that they reflect the light onto all directions, also one that has a high reflectivity (that is, that reflects most of the light with little absorption). Such diffuse reflectors are already in most rooms: the ceiling and the upper parts of the walls are indeed diffuse reflectors in most cases, and they have also high reflectivity, a characteristic that is much in request if the room is to look bright, so most white and off-white paints have reflectivities on the order of 90% or even higher.

It is worth to point out here that this problem would probably have been solved before was not for the energy wasting mentality of the post World War II in the United States. The lack of interest in the energy waste caused by the frosty enclosures reminisces the energy waste caused by the gas pilots that were constantly burning gas in the old American stoves.

FIG. 1 shows an incandescent E27-type existing device (old art in patent parlance), with a frosted glass enclosure insertable from underneath the E27 incandescent bulb upwards so as to completely surround the E27 incandescent bulb. Our invention is intended to replace this frosted glass enclosure around the E27 incandescent bulb, because it typically absorbs 25% and more of the light that propagates through it, which decreases the energy efficiency of the luminary by the same amount (25% typically, often more than 25%). Our invention has several incarnations, and we use the E27-type as an example for the main embodiment only, while disclosing several variations for other luminaries that use the same principle as discussed in the main embodiment below.

As the reader sees it now, the problem with the existing frosty glass enclosures is that they absorb too much light, which is a source of energy inefficiency. Our invention discloses the use of a reflecting surface so designed and located with respect to the luminary as to reflect the emitted light toward the higher part of the walls and to the ceilings, from where the light is reflected again, this time from a diffuse reflector (the wall paint), which is a very large total surface, to all points inside the room. Not only does the luminous emittance (that is, the light energy per unit surface) of walls is then even lower than the equivalent quantity at the legacy glass enclosure (the walls are less bright than the glass enclosures), but, being a larger surface that encloses all objects in the room, the light reflected by the higher walls and the ceiling produces a soft light that is devoid of shadows, which is better for vision—shadows are generally detrimental to visual perception. By higher walls we mean such a high part of the walls that the propagating light has only a small probability of reaching people's eyes. For example, it may be the higher 1% of the walls, or the higher 10% of the walls, or the higher 25% of the walls, or even the higher 90% of the walls, largely depending on the height of the room, but other factors too. As examples, a typical 3 m tall ceiling (10 ft) may only have light higher than 170 cm (5 ft 7 in), or the higher 130/300=0.43 of the wall height, that is, the top 43% of the walls, while a very high room, say, a 8 m (26 ft) tall ceiling, may still have light also as low as 170 cm (5 ft 7 in) that has little probability of directly hitting someone's eyes, so a 8 m high room may illuminate a fraction equal to (800-170)/800=0.7875 of the wall height, that is, the top 79% of the higher walls may be illuminated.

Our invention is adapted to be used with many designs of luminaries. We will be using as example of the main embodiment mostly the E27 Edison screw incandescent bulbs and their LED substitutes, of which there are many variations. FIG. 2 shows one type of LED substitute for the E27 incandescent bulb, one that emits light forward or near forward. The luminary shown in FIG. 2 is such that the LEDs emit light forward only, or almost forward only, say, within a cone of 30 degrees, or within a cone of 45 degrees, which contains (1−1/e)=(1−1/2.7182 . . . )=63% of the emitted light. These forwarding light emitting LEDs are one of the LED designs to substitute the common Edison screw E27 ordinary incandescents that illuminate most homes. Since so many not optimized LED substitutes have already been produced, and many more will be produced in the future too, they are common today and will continue to be so in the future, so it would be good to have a fix for them, similar to the fix for the blunder of Perkin-Elmer that polished the Hubble Space Telescope main mirror with a wrong radius of curvature, which was discovered after the telescope was up in space. The solution for the Hubble Space Telescope blunder was the addition of a correcting mirror, a mirror so polished that it canceled the image aberrations caused by the curvature error of the main mirror. Our solution for the poorly designed forward emitting LED is one such correcting device, a sister of the correcting mirror for the blunder of the Hubble space telescope main mirror. The addition to the luminary that we propose is of the same nature: to correct the forward emitting LED substitute for the E27 incandescents to cause that the resulting light is redirected to and concentrated on the ceiling and upper part of the wall, effectively causing a pleasing, soft lighting in the room, while also making redundant the frosty surrounding containers, eliminating the 25% and more light energy absorption caused by the frosty enclosures. Naturally that the walls and ceiling paint also absorb, but they typically absorb 10%, so our invention offers an energy utilization improvement of 15% and more, which is 10% loss with our invention against 25% loss with the old frosty enclosure of the past. As the reader will notice, the same correcting mirror works with the E27 incandescent bulbs, both cases making the enclosing frosted glass redundant.

The reader will notice that the correcting reflecting mirrors of our invention works better if they are positioned close to the emitting surface. This is illustrated at FIG. 3. In this figure the reader can see that a single reflecting surface, or louver (Louver2), at the bottom of the luminary, has to protrude further out of the luminary than louvers just next to each LED chip (Louver1), if it is intended to catch the same “light rays”, say, at 30 degrees angular aperture as shown. It follows from this fact that a good reflecting surface adapted to correct the illumination emitted by a corn-style LED substitute for an E27 incandescent substitute is as shown at FIG. 4, something that we mention here in anticipation for correcting mirrors to be used with the corn-style LED substitutes for the E27 incandescents. This figure shows one incarnation of our invention to be used on corn-style E27 incandescent substitutes that are to be inserted onto the female E27 receiving opening at the ceiling of a typical household room. In this figure one can see at the top two views of the structure of our invention adapted to redirect the light emitted by the corn-style luminary shown at the bottom of it: at left a view from the side of the device, and at right a perspective view of the device, that is, a particular incarnation of our invention designed to be used with the corn-style luminaries. This device can be added to any corn-style E27 substitute luminary simply inserting the corn-style LED luminary from the bottom up inside of our device, then screwing the luminary on the female receptacle at the ceiling pointing down. Inspection of the figure shows that once the corn-style LED substitute is inserted into the device of our invention, the corn-style luminary will move through the larger rings until the last smaller ring, at the top, where it stops. At this point, and if the luminary is vertically positioned, the correcting mirror insert is held in place by gravity, as its topmost ring is smaller than the luminary's diameter. Upon screwing the corn-style luminary into the vertically mounted E27 female receiving opening, the mirrors, or louvers, act to redirect the light emitted by each row of LEDs toward the wall and toward the ceiling of the room, from where the light is diffusely reflected to the room, causing a shadeless illumination with none of the bright spots characteristic of the LEDs. In other words, humans in the room below the luminary have no direct path of vision to the LEDs and so they are spared of the bright spots.

FIG. 5 shows an alternative to the device shown above at FIG. 4, this one for the case when the Hubble-Perkin-Elmer mirrors of our invention are designed to be part of the corn-style luminary at manufacturing time, as opposed as to be added to an existing corn-style luminary.

### Objects and Advantages

It is an objective and advantage of the device to cause a more evenly spread illumination in the room.

It is another object and advantage of the device to take advantage of the directionality of the light emitted by the LEDs to allow the elimination of scattering surfaces surrounding the new LED luminaries, because these scattering surfaces also absorb light, and light absorption decreases the overall energy efficiency of the LEDs as light sources.

It is another object and advantage of the device to make redundant the frosty scattering surfaces surrounding the old luminaries (e.g., E27 incandescents, tubular fluorescents and more), because these scattering surfaces also absorb light, and light absorption decreases the overall energy efficiency of the light sources inside it, because not all generated light actually enters the room, a good fraction of it being absorbed by the frosty luminary container.

Accordingly, one of the objects of our invention is to add reflecting surfaces strategically positioned near either the old energy-inefficient incandescent E27 Edison bulbs, tubular fluorescents, etc. and/or their new LED substitutes that are manufactured to have the same or similar light emission characteristics as their parent devices, as the corn-style LED substitute for the incandescent light bulb. The added reflecting surfaces redirect the emitted light away from the eyes of people in the space around and into such existing surfaces that serve as diffuse scatterers, from which the illumination is evenly distributed and comfortable to the people in the space that is being illuminated. Specifically, the emitted light is preferentially redirect to light colored walls and ceilings, which serve as diffuse scatterers which spread an even and pleasing illumination to the space around them, avoiding any bright light source. Ceilings and upper walls are not the only possibilities, but only the most common possibilities. By upper walls we mean the top 1% of the walls near the ceiling, or more, the top 10% of the walls near the ceiling, or in cases even more, as the top 25% of the walls near the ceiling, or in some cases even the top 50% (half) of the walls near the ceiling, and in some cases even the top 90% or the walls near the ceiling. In general the actual value depends on the height of the ceiling and the position of humans in the space below. For example, a typical 3 meters high room (10 feet in US), should not have LED originating light from a forward emitting incandescent substitute lower than 1.6m, corresponding to the height of the eyes of a 1.7 m human (approximately 5 ft 2 in and 5 ft 7 in.), which, on a 10 m square wide room, with a luminary at the center of its ceiling means that the angle of the reflected light should be less than arc tg ((3−1.6)/5)=16 degrees. It is also worth to mention that some luminaries emit light with a fairly large aperture (emit light into a large angle), with a decreasing light brightness around a central direction; for these luminaries it is usually agreed that all light is emitted into the directions that contain (1−1/e)=(1−1/2.7182818 . . . )=1−0.3679=0.632 of the emitted light energy.

Another object and advantage of the invention is the energy savings that can be obtained with the elimination of the frosty cover on the ceiling luminaries that normally enclose the luminaries, as the E27 incandescent bulbs at the ceiling of most homes. The common frosty covers for the ceiling luminaries are used to decrease the intrinsic brightness (luminous emittance) of the luminaries inside, preventing too bright a light into the eyes of persons in the room. The problem is that the covers also absorb some of the light, which is a waste of the electrical energy used to produce the light that is absorbed by the frosty cover. The energy savings produced by our device is obtained with the elimination of the frosty cover, but, of course, while still preventing direct bright light onto the eyes of the people in the room. Our device is an attachment to the luminary that, taking advantage of the directionality of the LEDs, simply redirects the emitted light to the ceiling and to the upper part of the walls, as the upper 50% of the walls, or better, the upper 20% of the wall, or better yet, the upper 10% of the wall, or even better, the upper 1% of the wall, which then creates a pleasant soft illumination over the whole room. Our device has as many different incarnations as there are shapes of LED substitutes for legacy incandescent, fluorescent, lamps etc., and we will discuss here the shape to be used with forward emitting LED which are substitutes of vertically mounted, downward pointing, incandescent substitutes.

Another object and advantage of our invention is the increase in light energy per electric energy spent. We claim that our invention increases the amount of available light intensity in the room where it is used. At this point we request that you, the reader, try an experiment when you return home, which will bring to your attention the magnitude of the wasted light energy: indeed the energy waste is so much that it is detectable with the naked eyes! The experiment consists in having a friend to go up to any of these ceiling luminaries and take the frosty cover and put it back in succession while you look around the room. Your friend is not supposed to tell you when he inserts the frosty cover and when he takes it out, and we guarantee, because we did it, that the reader will know unequivocally when the frosty cover is on and when it is out. This experiment will show the reader the amount of lost illumination caused by the frosty covers, so the reader will see what this is about—and also how bright is our invention! If it becomes difficult to do the experiment at the ceiling with the frosty covers, because maybe you do not have a ladder, you should try it later anyway, but a related easier experiment can be done with any floor or table lamp provided with a shade. Lamp shades exist for the same reason, to prevent too bright a light on the eyes of people, and they also absorb light, but the effect is not so strong as the ceiling covers, because the light emitted vertically by the floor lamp, upward and downward, do so unimpeded, so the fraction of the absorbed light by the shade is smaller than the fraction of the light absorbed by the frosty cover on the ceiling, and consequently the light (and energy) loss is less with the lamp shade. So, in a bind do it with the lamp shade, but the reader is urged to do it with the ceiling frosty cover too, as soon as possible.

Other objects and advantages of my invention are making unnecessary the light-scattering/light distributing devices around the incandescent E27 light bulbs, fluorescent lights, etc., including their LED-substitutes that have equivalent light distribution of their parent devices.

Other objects are to decrease the cost of light fixtures, obviating the need of the scattering screens around the incandescent light bulbs and fluorescent lights of the past, and their new LED-substitutes that emit light with similar light distribution in space.

Other object is to further increase the energy efficiency of the modern LED lighting devices, particularly the ones designed to substitute old light bulbs devices, because the scattering covers also absorb light energy, so their elimination increases the light intensity available for the object of illuminating the space.

Other object is to further increase the energy efficiency of the legacy luminaries, particularly the dinosaur-type old E27 incandescent light bulbs devices, because the scattering covers also absorb, so their elimination increases the light intensity available for the object of illuminating the space.

Another object and advantage of our invention is to correct the geometrical inadequacies of improperly designed LED substitutes for legacy luminaries, as the substitutes for the E27 incandescent bulbs, the substitutes for the tubular fluorescents, etc. Our device does also improve the efficiency of the legacy luminaries, as the incandescents, the fluorescents, and others.

If one or more of the cited objectives is not achieved in a particular case, any one of the remaining objectives should be considered enough for the patent disclosure to stand, as these objectives are independent of each other.

### SUMMARY OF THE INVENTION

The invention discloses a method and means to redirect the light emitted by currently used LED light sources that emit light either isotropically or quasi-isotropically to imitate the older luminaries (e.g. E27 Edison and the tubular fluorescents) into such directions as to obviate the need of light scatterers surrounding the light sources. The invention also applies to new LED replacements to old-style luminaries that emit light along one direction only, or along a few directions only, as a forward only emitting E27 incandescent replacement. The same method and means may be applied to the former luminaries being substituted by the LED-substitutes, as the E27 Edison incandescents, the tubular fluorescents, etc. The LED light sources that are currently manufactured typically have a plurality of relatively small LED light emitters distributed on part of the surface of the supporting structure, which typically emits light on a 4*pi stereoradians, that is, isotropically.

### BRIEF DESCRIPTION OF THE DRAWINGS

FIG. 1. Old art incandescent luminary.

FIG. 2. Example of forward emitting incandescent substitute E27 LED luminary.

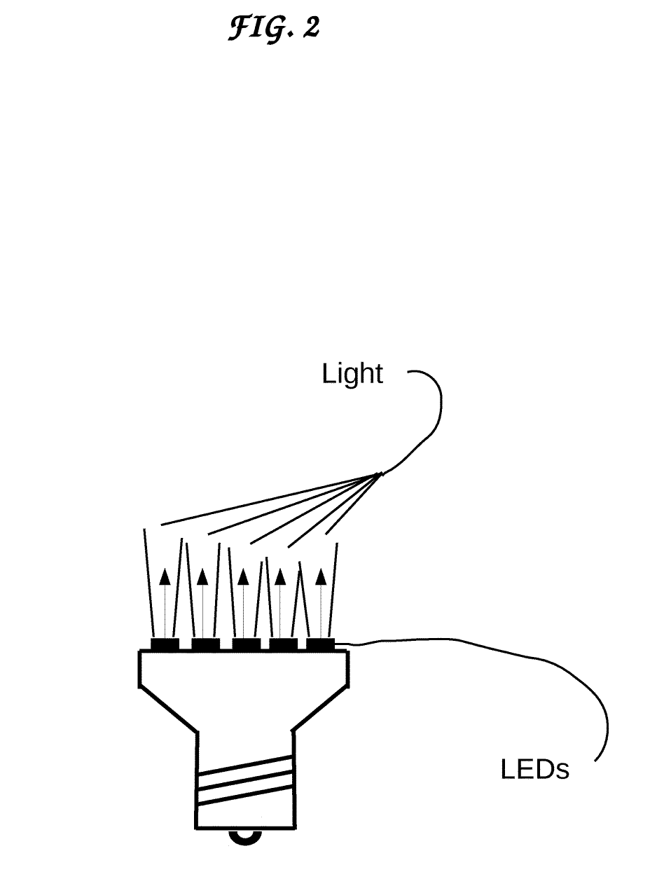

FIG. 3. The reader will see that a single louver (Lover2) at the bottom of the luminary has to protrude further out of the luminary than louvers just next to each LED chip (Louver1) if it is intended to catch the same “light rays”, say, at 30 degrees angular aperture as shown.

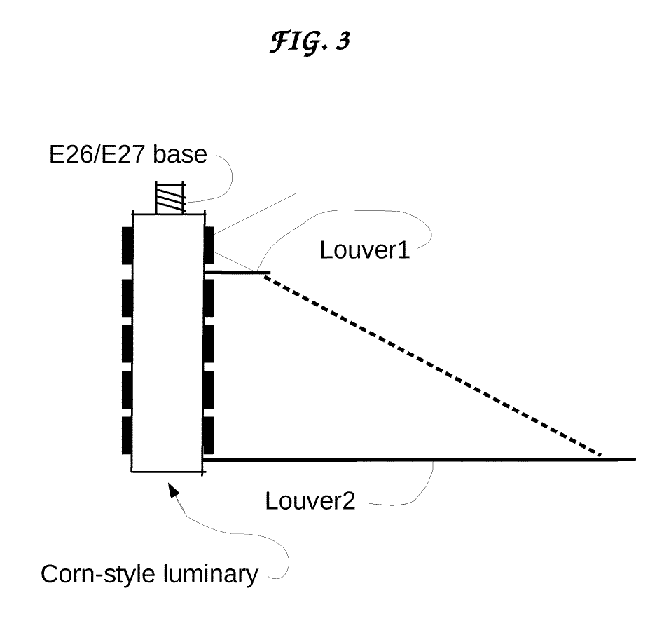

FIG. 4. Example of insertable Hubble-Perkin-Elmer correcting mirror to frustrate light into undesirable directions. The invention is insertable into existing corn-style LEDs made to substitute old incandescent E27 luminary.

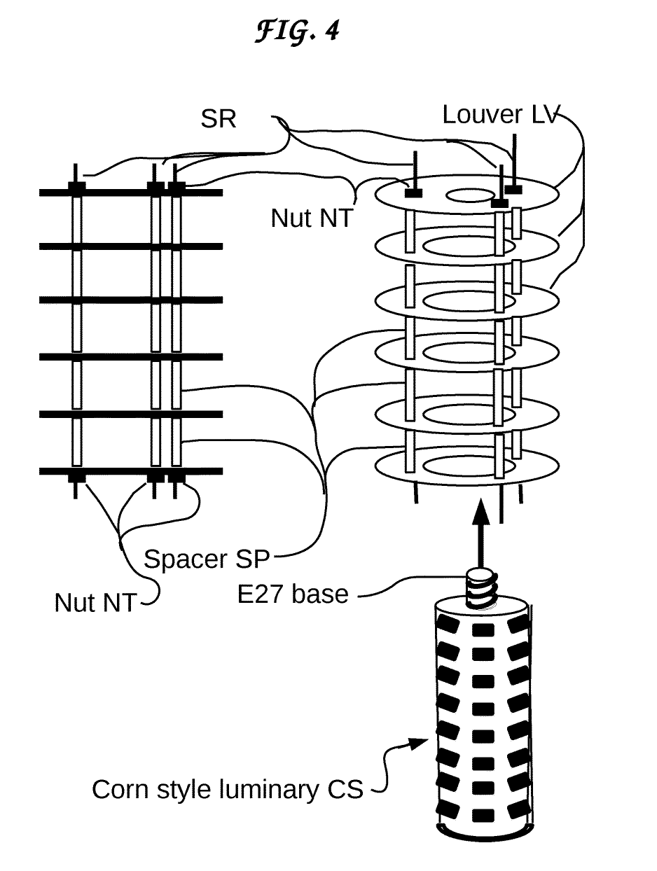

FIG. 5. Corn-style E27 substitute already including the Hubble-Perkin-Elmer device of our invention. In this case the Hubble-Perkin-Elmer device is part of the new luminary, as opposed to FIG. 4, which is to correct already existing corn-style luminaries.

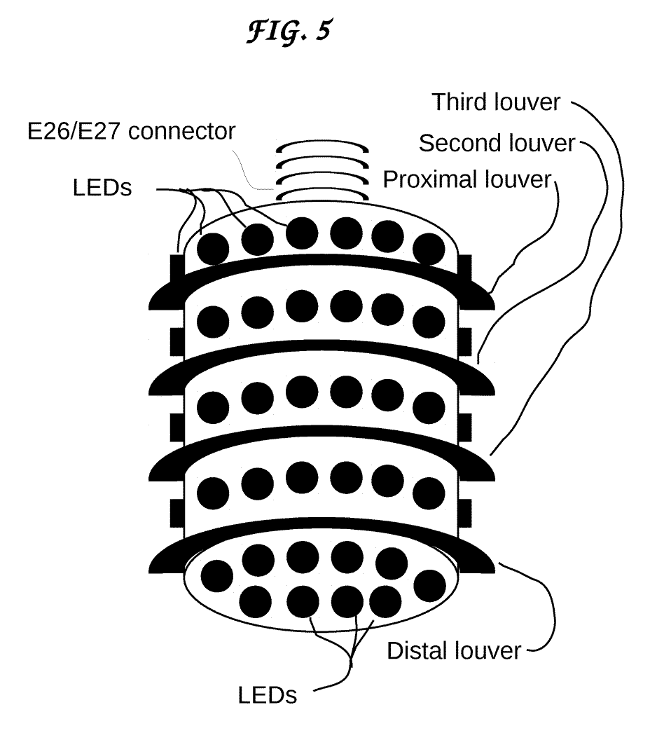

FIG. 6. Hubble-Perkin-Elmer correcting mirror of our invention under existing incandescent E27 luminary.

FIG. 7. The reader will see that a single mirror (Mirror2) at the bottom of the luminary has to protrude further out of the luminary than mirrors just next to each LED chip (Mirror1) if it is intended to catch the same “light rays”, say, at 30 degrees angular aperture as shown.

FIG. 8. Alternative supporting structure for the Hubble-Perkin-Elmer correcting mirror of our invention. In this case the Hubble-Perkin-Elmer correcting mirror is supported by the luminary, instead of supported by the structure attached at the ceiling.

FIG. 9. Example of Hubble-Perkin-Elmer correcting mirror.

FIG. 10. Another example of Hubble-Perkin-Elmer correcting mirror of our invention.

FIG. 11. Still another example of Hubble-Perkin-Elmer correcting mirror of our invention.

FIG. 12. Another example of Hubble-Perkin-Elmer correcting mirror of our invention.

FIG. 13. Another example of Hubble-Perkin-Elmer correcting mirror of our invention with supporting cables.

FIG. 14. Another example of Hubble-Perkin-Elmer correcting mirror of our invention with an LED luminary.

FIG. 15. Still another example of Hubble-Perkin-Elmer correcting mirror of our invention.

FIG. 16. A blown out version of the insertable Hubble-Perkin-Elmer correcting mirror designed for use with a corn-style LED substitute for the E27 incandescent bulb. At top left is a side view of the insertable device, at top right is a perspective view of the same, and at the bottom is a corn-style luminary that is insertable into the invention as shown by arrow.

FIG. 17. Still another example of Hubble-Perkin-Elmer correcting mirror of our invention, with supporting cables and a new LED forward emitting LED luminary.

FIG. 18. A version of the Hubble-Perkin-Elmer correcting mirror for the tubular fluorescent luminary commonly used in school, businesses and industrial facilities.

FIG. 19. Same as FIG. 18 including supporting cables.

FIG. 20. Same as FIG. 18, this time including an extra Hubble-Perkin-Elmer reflecting mirror at the top to collect light emitted upwards.

FIG. 21. Several variation of the Hubble-Perkin-Elmer correcting mirror of our invention.

### DRAWINGS

### List of Reference Numerals

Refl_Surf1=First reflecting surface.

Refl_Surf2=Second reflecting surface/louver.

### DETAILED DESCRIPTION

The main embodiment of our invention is a device consisting of a reflecting surface (as a mirror) attached by convenient means (described in the sequel) in the vicinity of either an old-style luminary or to some of their LED-substitutes, as the dinosaur-type E27 incandescent bulb or some of its LED-substitutes, such that it is vertically mounted at the ceiling of a room, which makes that the luminary is vertically oriented pointing down to the floor, which is a common arrangement in homes. Variations of the supporting structure make the detailed description, which is for a ceiling mounted E27 style socket and electrical connection, to also work with other mountings.

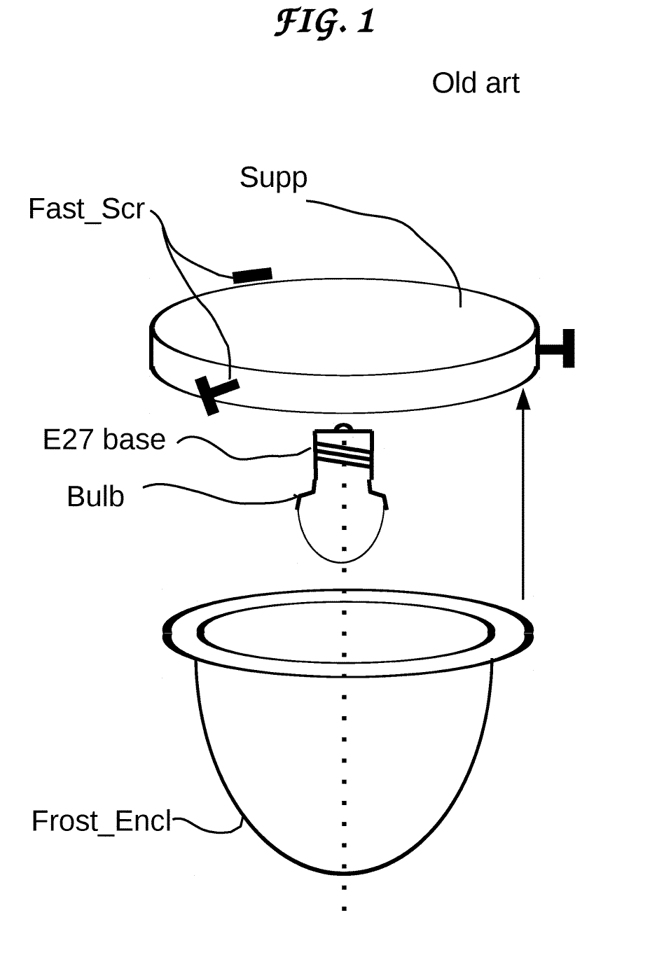

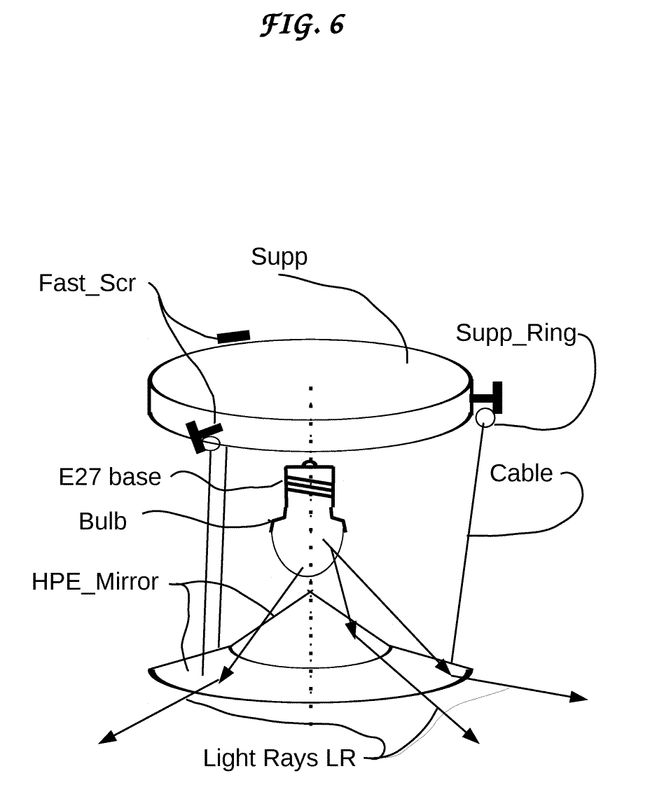

We start the description of the main embodiment of our invention with the description of the existing device the our invention modifies. FIG. 1 shows an incandescent E27-type existing device, with a frosted glass enclosure insertable from underneath the E27 incandescent bulb upwards so as to completely surround the E27 incandescent bulb—this is old stuff, known in attorney's lingo as “old-art”, depicted here only to show the change our invention makes on the existing devices. FIG. 6 shows the main embodiment of our invention. Our invention gets away with the frosted glass enclosure Frost_Gla, adding instead of the frosty enclosure a hanging Hubble-Perkin-Elmer correcting mirror HPE_Mirror. We call the Hubble-Perkin-Elmer correcting mirror in memory of the Hubble telescope blunder that none of the engineers and techs detected while still on the ground at the American high-tech company Perkin Elmer, in Connecticut. The main mirror was incorrectly polished at Perkin Elmer, so the images were no better than the images from an amateur telescope at the ground. After a scary period of consternation within the astronomer's community, it was suggested to add a correcting mirror to the telescope, which was so polished as to undue the errors on the incompetently polished main mirror. The Hubble telescope was then corrected with an additional mirror, and the improperly designed luminary can likewise be corrected with an additional mirror, in this luminary case not to correct a blurred image but to make the device more energy efficient, in the sense of providing more visible light energy (photons) in the space, for a given amount of electrical energy spent on the luminary.

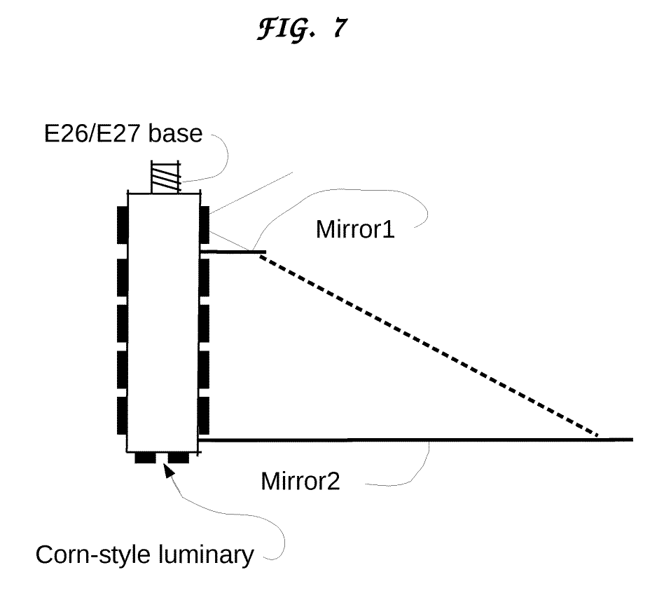

Again referring to FIG. 6, it is seen the main embodiment of our invention. In it one can see the supporting structure Supp that is used by existing luminaries (old art in patent lawyers jargon), which is attached to the ceiling, which is designed to support a frosty glass or plastic enclosure that surrounds the E-27 incandescent bulb inside it. The type shown in this figure is one of the most common at the ceilings of home, though not the only one, and the three screws hold the frosty enclosure as they are tightened under the flip at the top opening of the frosty enclosure. In this figure one can also see an incandescent bulb, which is screwed onto a female receptacle (not shown) vertically mounted at the ceiling. The incandescent bulb emits light towards all directions with the proviso that light that is emitted straight backwards, toward the incandescent's base socket is generally absorbed by the structure, but this is a minuscule fraction of the light energy and it is not considered here. Part of the light emitted by the incandescent luminary is emitted generally speaking upwards, towards the ceiling, from where it is diffusely reflected into the room below, contributing to a pleasing evenly distributed light. Likewise for the part of the light emitted horizontally or just below the horizontal direction, which hits the upper walls of the room, from where it is diffusely reflected into the room below, also contributing to a pleasing evenly distributed light. The remaining light, which is approximately less than 50% of the light energy, is emitted down into the room, forming a too bright source that inconvenience the humans below, which is the reason for the frosty covers of the past, the covers that are being substituted by our invention. Our invention is the Hubble-Perkin-Elmer correcting mirror (HPE_Mirror), which, for this embodiment, is positioned just below the luminary, as close as possible to it, as seen at FIG. 6. As the reader can see from the figure, all the light propagating within a cone with an apex angle of approximately 140 degrees is bound to disturb people below because the source generally has too large a luminous emittance (too bright light in common parlance). Light emitted outside (above) such a cone is likely to hit the higher part of the walls, outside the path into people's eyes below, from where it reflects diffusely and does not disturb people in the room. Our invention is our amazingly cleaver Hubble-Perkin-Elmer correcting mirror (HPE_Mirror), located under the luminary. As the reader can see, the Hubble-Perkin-Elmer correcting mirror redirects the light from a path that would inconvenience people below, towards a direction that is close to or above the horizontal and, because of the position of the Hubble-Perkin-Elmer correcting mirror, will propagate toward the upper part of the wall surrounding the luminary. The amount of light energy that is reflected by our Hubble-Perkin-Elmer correcting mirror depends on the distance between the mirror and the luminary; in general light is reflected that is propagating outward from the luminary within the angle subtended between the light emission point (roughly the luminary itself) and the outer edge of the Hubble-Perkin-Elmer correcting mirror. Therefore, given that it is more advantageous to redirect as much of the light energy as feasible, the Hubble-Perkin-Elmer correcting mirror should be placed as near as possible to the luminary above it in the main embodiment. FIG. 7 shows this dependence between the size of the correcting mirror (or its diameter) and the distance between the correcting mirror and the LED or other light source. Observation of FIG. 7 should convince the reader that the Hubble-Perkin-Elmer correcting mirror should be placed as close as possible to the luminary.

Most of the walls are painted with off-white (or totally white), with a reflectivity of around 90% (that is, with a 10% loss to absorption), and the painting is usually a diffuse reflector, so all the reflected light that reaches the walls and the ceiling is reflected again, this time with a loss of 10% (typical value) to all directions into the room. This last characteristic is important for the invention too, because the consequence of it is that any and every point in the room receives light that has been scattered by a large surface area (the higher walls and the ceiling), which means that the illumination is soft and devoid of sharp shadows. It follows that no point at the wall is too bright, since the original light is spread over a large surface at the upper part of the walls and the ceiling, and also that the light that then propagates into the room has suffered an attenuation of just 10% (typical value), as opposed to an attenuation of 25% due do the absorption of the old-style, dinosaur-type glass or plastic enclosure the ridiculously energy inefficient type of incandescent bulbs.

In anticipation of some reader's observation that there are multiple reflections within our invention, which is true, each causing an approximately 10% absorption, we reply that this indeed occur, but it does occur for both the frosty enclosure (old art) and the HPE_mirror: both cases involve multiple reflections at the walls, so this is no worse for our invention than it is for the frosty enclosures. It only means that the actual available light energy is somewhat less than 25% and 10% loss, but it is less by the same amount, say 25%−x % and 10%−x %, so the difference is always still 15% in our favor. Again, in anticipation of criticism, the 25% and 10% values that we are using here for analysis are typical values, which are different in each case.

For the main embodiment the additional mirror HPE_mirror is kept in fixed position under the luminary, as shown, preferably just below the luminary, say, with its tip at 1 mm below the bottom of the luminary. The distance to the luminary is important, as said above and as it will be explained below, though this distance suggested here is not mandatory, not the only possibility for the invention, other distances being also possible, depending on the circumstances. The correcting mirror for the main embodiment has a shape that reminds a Vietnamese hat, but this is not the only possible shape, other shapes being equally acceptable that redirect the light to the higher walls and to the ceiling.

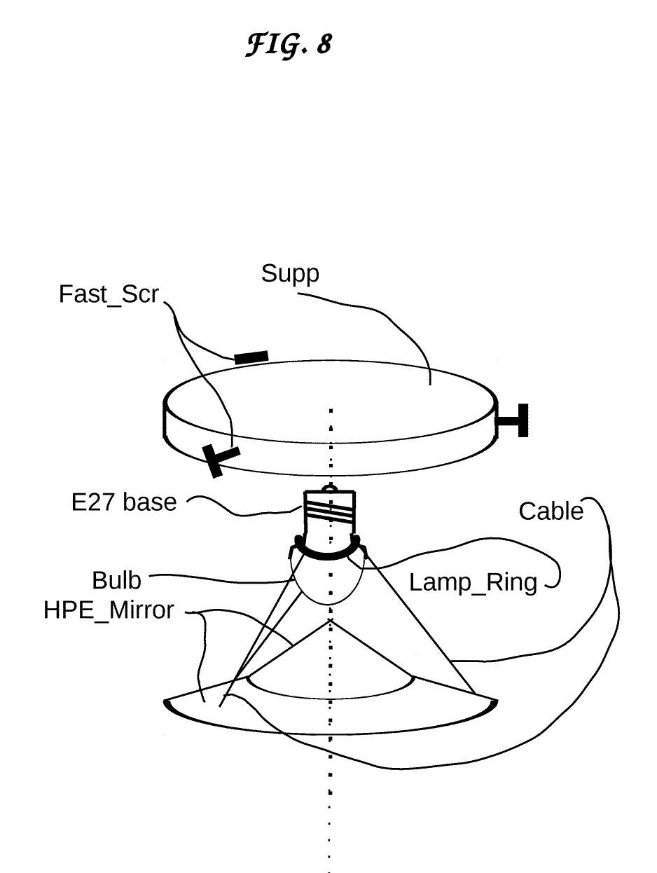

The correcting mirror is, for this main embodiment, a cone followed by a truncated cone, but this combination is not necessary, a single cone being also a possible main embodiment of the invention, or a cone followed by two truncated cones, one after the other (not shown), etc. The reflecting mirror HPE_mirror is kept in place under the luminary by three cables (or strings, or rods, or wires, etc.), labeled “cable” in the figure, each cable terminating on a ring at its upper extremity, further away from the Hubble-Perkin-Elmer correcting mirror, labeled Supp_Ring in the figure, which is of such a size as to be insertable in the fastening screws Fast_Scr that in the traditional luminary are used to held the frost cover in place, as shown in the figure. This particular hanging method is not the only one, any other mechanical support being equally acceptable. In the main embodiment the correcting mirrors are kept in place by three supporting cables spaced 120 degrees apart around the conical mirrors, which are attached at the usual three screws that traditionally support the milky (or scattering, of frosty) surfaces that surround the traditional E27 luminary at the ceiling of many household rooms, but more cables or less cables are possible, still not changing the invention. For example, it is possible to suspend the HubblePerkinElmer correcting mirror directly from the ceiling, instead of three cables attached to the three screws intended to hold the traditional frosty enclosure around the incandescent bulb, and this is an obvious modification intended to be protected by our disclosure. Or it is also possible that the HPE correcting mirror may be supported from a ring which is placed around the E27 neck, just below the E27 screw, as shown at FIG. 8. Such a ring could not fall through the incandescent bulb (or its equivalent substitutes) because the cylinder of the LED substitute (or the body of the incandescent) is wider than the screw intended to penetrate the female receptacle above it. In this figure one sees a ring (Lamp Ring) which is inserted from the E27 screw side of the luminary, which has a smaller diameter than the bulb itself, and which, in the vertical ceiling configuration used for the main embodiment, is kept in place by gravity, which is the supporting structure for the three (or more) cables labeled Cable at the figure, which finally support the Hubble Perkin Elmer mirror of our invention. There are an infinite number of other possibilities to keep the correcting mirror in place, and the particular one chosen is included in our invention.

For example, it is possible to suspend the HubblePerkinElmer correcting mirror directly from the ceiling, instead of three cables attached to the three screws intended to hold the traditional frosty enclosure around the incandescent bulb, and this is an obvious modification intended to be protected by our disclosure.

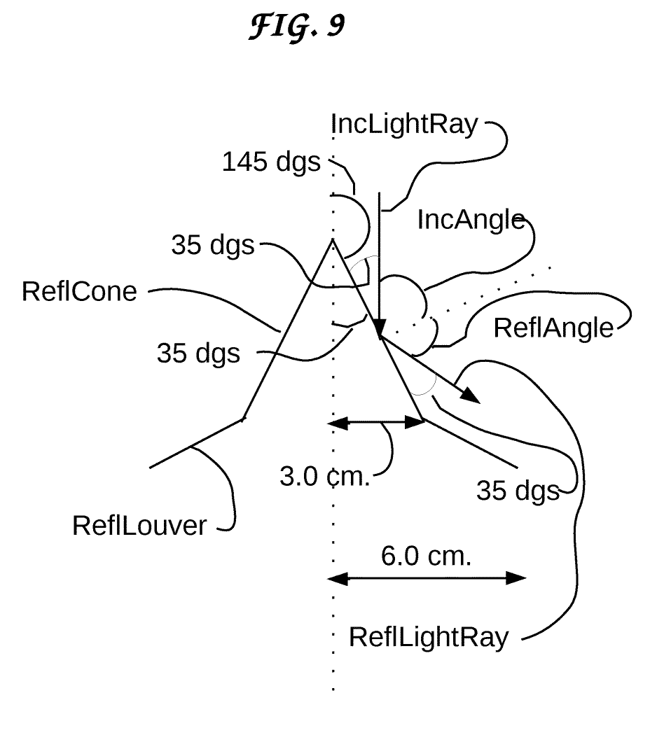

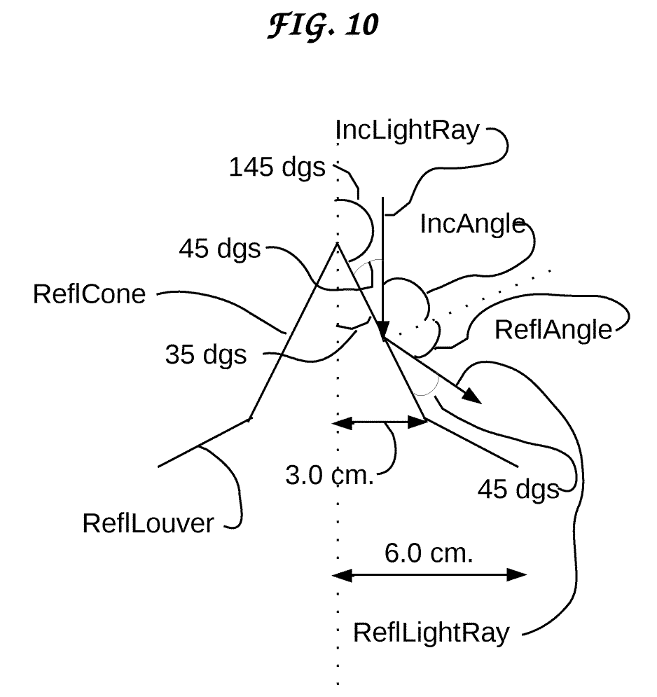

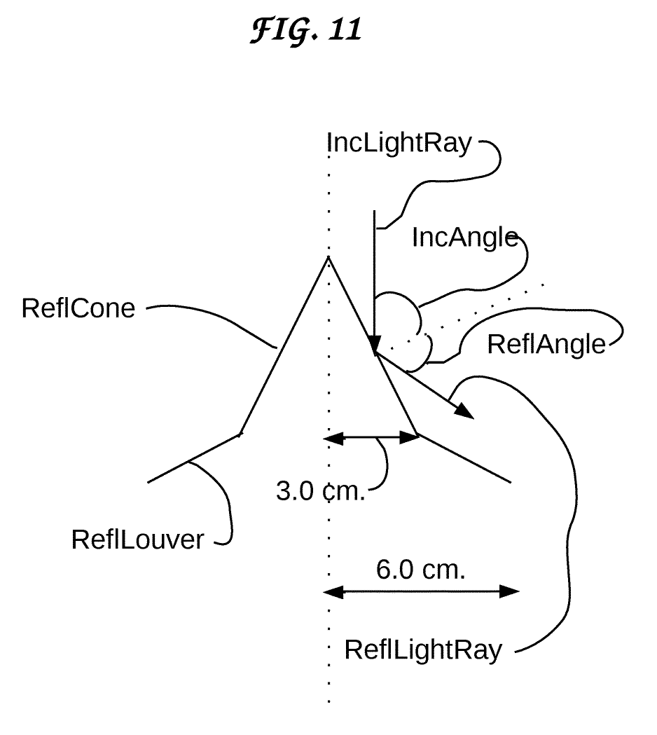

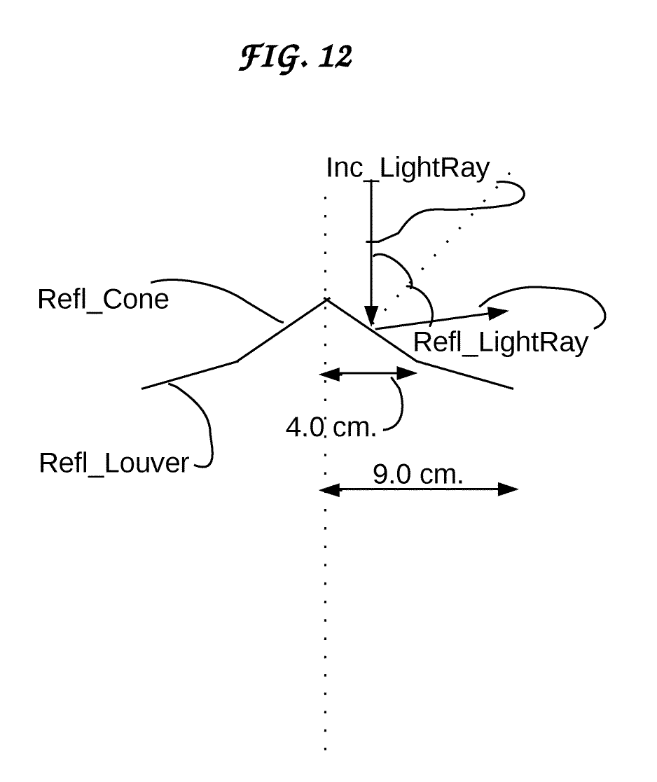

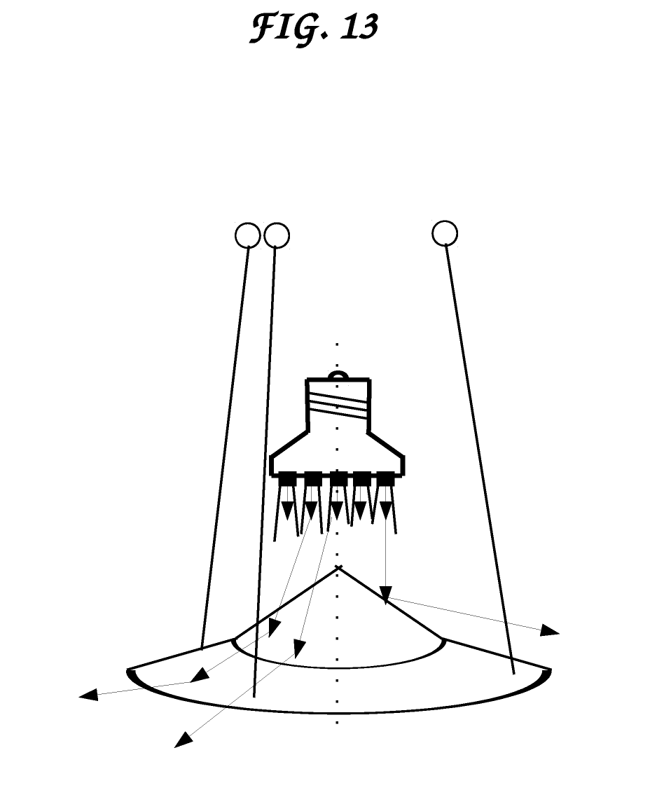

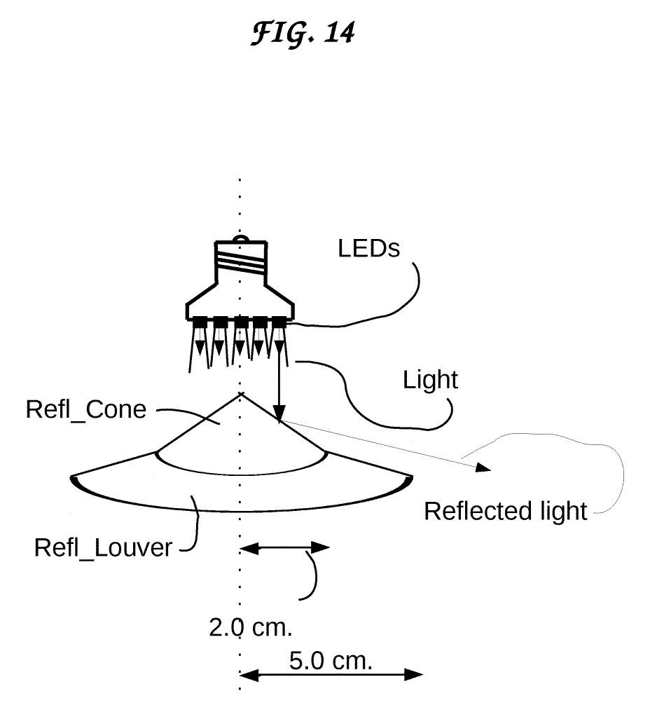

FIGS. 9, 10, 11, 12, 13, 14, 15 show several views and variations of the main embodiment that are so similar as to be the same invention. In particular, the correcting mirrors need not be a cone followed by a truncated cone, but may equally be one cone only, with larger or with smaller apex angles (which means wider bases or narrower bases), or some other shape, geometric shape or not, a shape describable by one simple equation in analytic geometry or not easily describable by an equation in analytic geometry. The cones may be mirrors or may be simple polished glass surfaces. If these later, they would still be very good reflectors because the angle of incidence would be close to 90 degrees, which, by Fresnel equations, guarantee large reflecting coefficients, in which case a small fraction of the light would be transmitted directly down, not too much as to be annoying to the eye (the reader is here reminded that in optics all angles are measured with respect to the normal, or perpendicular to the surface, which means that 90 degrees is a grazing angle of incidence, as the sun setting over the horizon). The cones may also be unpolished surfaces, in which cases they act as partly or totally diffuse reflectors. The cones may be made of polished metal or any other material, including plastics, to decrease the cost and weight.

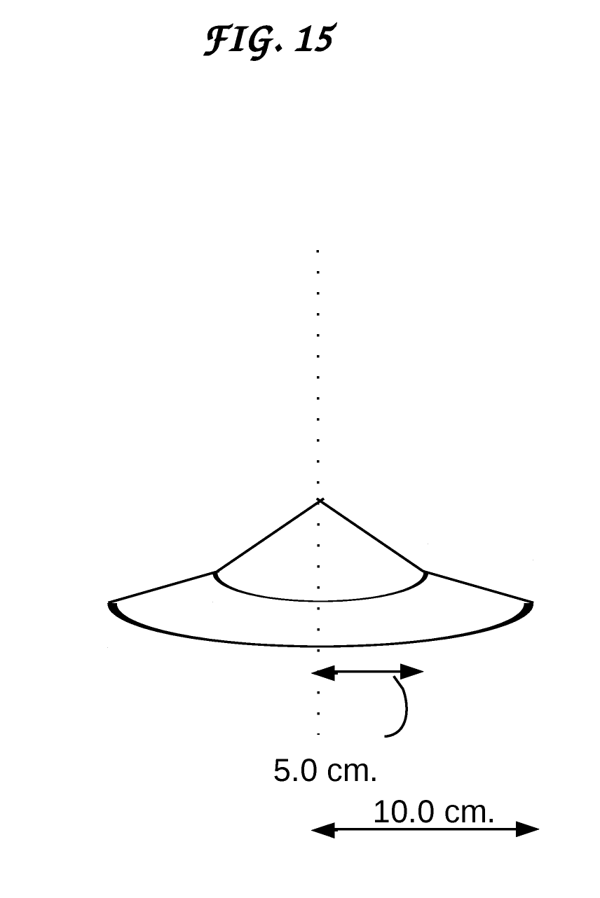

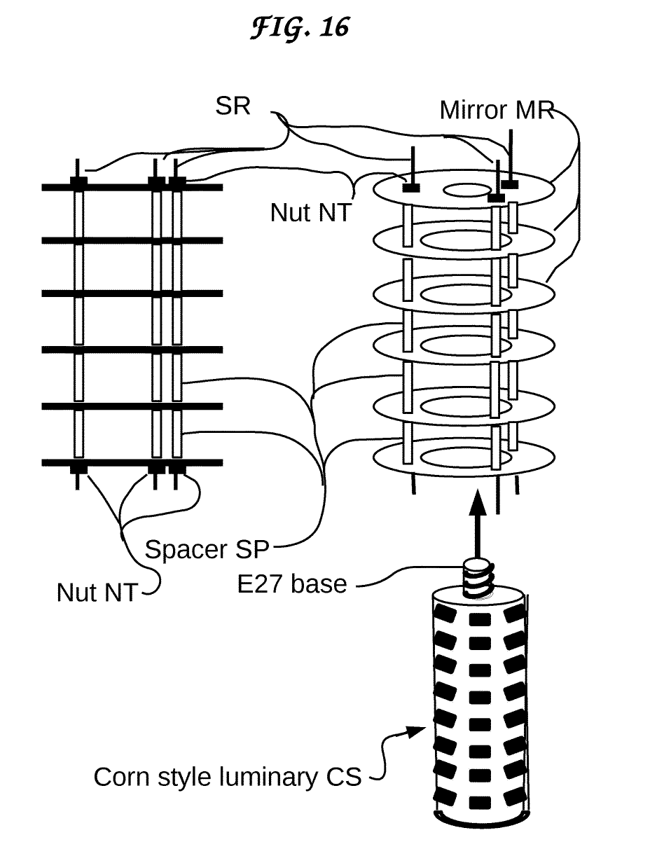

Also, the luminary may be a forward emitting LED substitute for the incandescent bulb, as shown in FIG. 15 and other figures with variations cited above. Or the luminary may be a corn-style LED substitute for an E27 incandescent bulb, in which case the conical reflector, or Vietnamese hat of the main embodiment, may represent only part of what is required to prevent light into the eyes of people in the room, with additional reflecting surfaces near the LEDs located at the sides of the corn-style luminary, as seen at FIG. 16. This figure shows a series of reflecting mirrors labeled Mirror_MR, one under each set of LEDs around the perimeter at the same axial position on the cylinder, together with a system to adapt the structure to different sizes of corn-style LED luminaries. Each two ring shaped mirror Mirror_MR is separated by a spacer labeled SP, which has a length such that each mirror MR is just below a series of LED around the perimeter of the cylinder. The whole set of spacers SP are kept in place by a smaller rod that runs inside them all, and through holes conveniently drilled on the mirrors MR, and the whole structure is kept fixed by nuts NT screwed onto the tapped ends of the supporting rod SR (not shown).

In fact, an infinite number of modifications are possible, varying the shape and size of the reflecting surface near the luminary, or the method to keep the reflecting surface fixed in space, or changing the material of the reflecting surface, or changing the surface structure of the reflecting surface and more, which are variations that are intended to be included in the invention.

It is preferable that the correcting mirror be situated just below the luminary, say, with its tip at 1 mm below the bottom of the luminary, or more, as 1 cm below the bottom of the luminary, or perhaps a little lower, as its tip 5 cm below, or even more, 10 cm below, or even more, the actual distance from the bottom of the luminary to the top of the HubblePerkinElmer correcting mirror not changing the spirit of the invention. The distance below the luminary matters, as shown at FIG. 7, where the reader can see that the farther the reflecting mirror is from the light source, the larger it has to be if it is to cover the same angular aperture around the light source. For this reason the Hubble-Perkin-Elmer mirrors are drawn close to the incandescent light bulb in FIG. 1, though this closeness is not necessary, but only an advantage to make the mirror smaller in size.

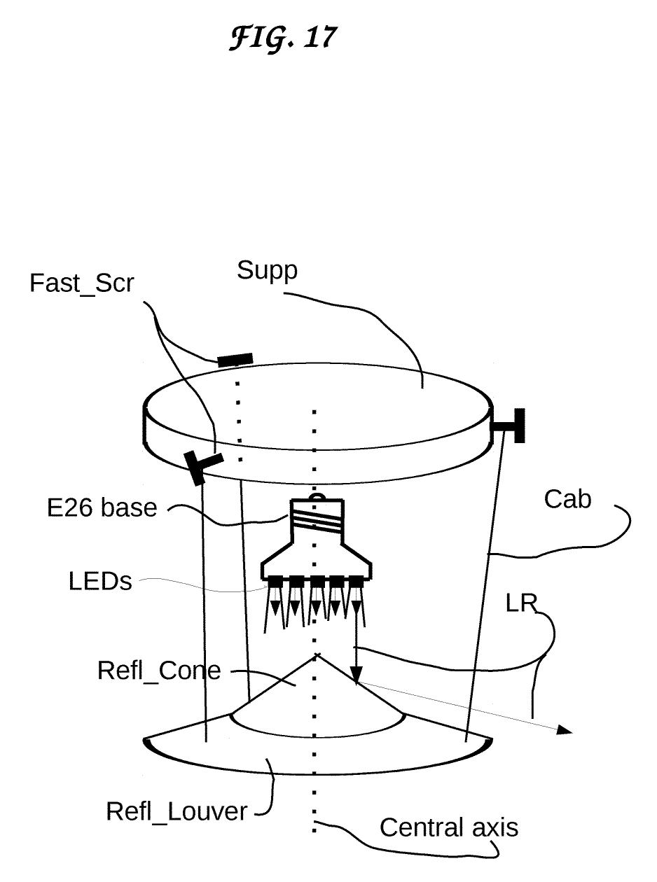

This is the physical arrangement shown at FIG. 17 which happens to depict an LED-type substitute for an incandescent bulb, but it could be an incandescent bulb as well. We will use the E27 example (E26 in USA), with the ubiquitous 3-screw holder for the larger frosty enclosure that often surrounds the incandescent bulb inside it, but obvious modifications for other luminaries are intended to be included in our invention. Or the HubblePerkinElmer correcting mirror may hang from a ring surrounding the upper part of the incandescent bulb, or an LED-substitute of it, just below the E27 screw, as seen at FIG. 8. We also explicitly show variations of the main embodiment for the tubular fluorescent lamps that dominate the commercial and instructional facilities, for the corn-style substitute of the E27 incandescent and for a few other luminaries and/or attachment variation.

### Operation of Invention

The objective of artificial illumination is, in the majority of cases, to spread the light in such a way that the full room is diffused with an even illumination reaching everywhere in equal intensity from all directions. Museum rooms, display cases, educational shows, and others are exceptions that may not be included in our analysis. Our invention operates on the fact that the LED light emitting elements of the LED light substitutes for all the existing technologies are all small in size (a few square mm) and all emit on a narrow cone of light (though not as narrow as a laser diode!). The operation of our invention is then to locate the Hubble-Perkin-Elmer correcting mirrors in such positions and along such orientations that they point toward a nearby white surface (higher reflectivity and small absorptivity and transmissivity), from which light is scattered at all angles towards the space which is to receive illumination. A second operational goal of the invention is to avoid direct light from the luminaries into the eyes of the humans in the environment, for any and all cases when the luminaries are characterized by a too high luminous emittance (too bright in normal language).

The operation of our invention is the redirection of the light energy from an undesirable propagation direction to another direction that is more desirable. Most often, but not necessarily exclusively, an undesirable direction exists when a bright light source emits light (or part of its light energy) along such a direction that it can be seen directly by humans in the environment. This direct exposure to the light is undesirable when the light is too bright, the maximum amount being a subjective, yet valuable measure if agreed upon by a large number of people. The method of operation of our invention is to add reflecting surfaces, the Hubble-Perkin-Elmer correcting mirrors, which are positioned along the undesirable directions, so as to block light propagation along these directions, and oriented along such directions that the reflected light propagates toward surfaces that are characterized by a reflectance of at least 50%, or better, a reflectance of at least 75%, or even better, a reflectance of at least 90%, which are also diffuse reflectors. These conditions are easily met by the paintings on most walls, which are diffuse reflectors in the almost totality of cases, and which are, on purpose and always, as high reflectance as reasonably possible to make, usually 90% reflectance and more. If then the Hubble-Perkin-Elmer correcting mirrors are so oriented as to reflect the light out of the initial path that would annoy people due to high luminous emittance (too bright in laymen's words) onto directions such that the new propagation directions is unlikely to intercept the eyes of most human beings in the room and if also this reflected light spreads over a diffuse reflecting surface that is also a good reflector, then the room would be illuminated by a pleasing soft light which comes from many directions, an illumination that would also be devoid of shadows, which is another advantage of the invention.

One common situation is that the Hubble-Perkin-Elmer correcting mirror is added below a ceiling luminary and is so oriented as to reflect the light toward the upper portions of the walls and to the ceiling of the room. In most of the cases the large reflective surface is the higher part of the walls and the ceiling of the rooms, which are generally light colored, with a reflectivity of 0.9 or larger. By higher part of the wall, we mean the 1% higher part of the wall, or the 10% higher part of the wall, or the 30% higher part of the wall, or the 50% higher part of the wall, or even 90% higher part of the wall, depending on the height of the room.

### Description and Operation of Alternative Embodiments

We used the A-series (Edison screw base) filament light bulb as the main embodiment, but the inventive method of directing the emitted light toward highly reflective surfaces, as the ceiling and higher sections of the walls, with view of not allowing the light beam to pass through paths which may cross the eyes of people, is perfectly transferable to other luminaries. It is quite possible to use the inventive method with other standards different than the A-series, adapting the hardware to each case, mostly a different configuration for the Hubble-Perkin-Elmer correcting mirrors. The adaptation to each case is to keep the method of directing the light emitted by the luminaries towards surfaces with high diffuse reflectivity (preferably) and at such light paths that human eyes are not expected to be in the light path.

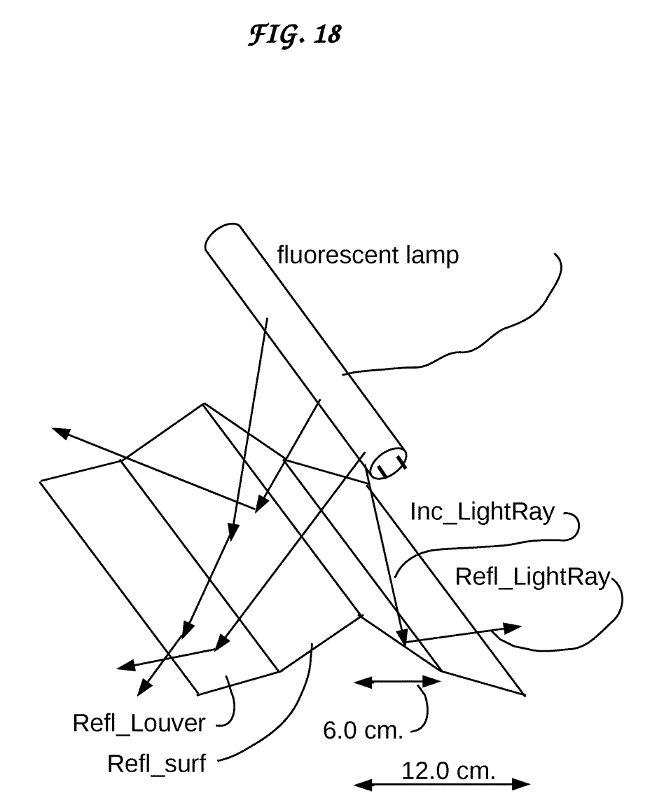

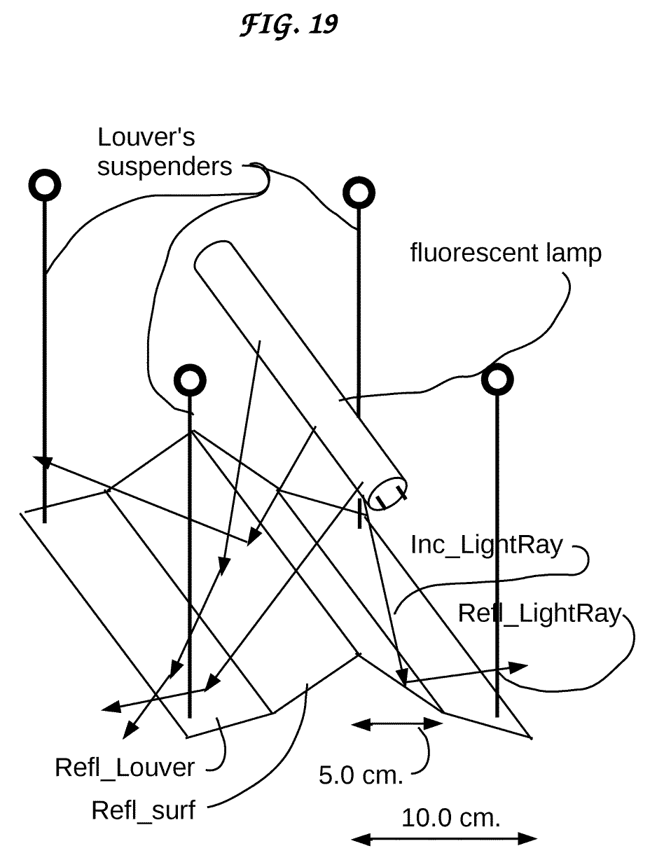

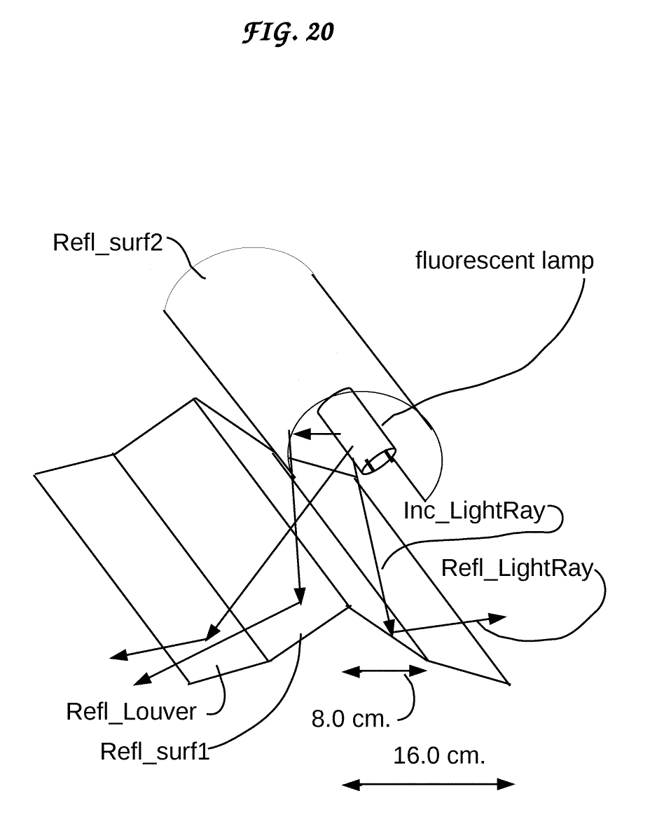

An example of another mounting standard and technology is the long, cylindrical fluorescent lamps used in business, the lamps known by the numbers of the form F##T##, where “F” stands for fluorescent, followed by two digits that indicate either the electrical power or the length in inches, then the letter “T” indicating that it is a tubular shape, then two digits indicating the tube diameter in ⅛ inch units. We include the substitutions for such lamps with an adapted distribution of LEDs on a tubular support that has the same dimensions as the fluorescents, to be physically compatible with them. Generally the Hubble-Perkin-Elmer correcting mirrors for the tubular case depends on they being single or multiple tubes and depending on they being recessed into the ceiling (the most common case in businesses) or being hanging down from the ceiling, a generally older practice less used nowadays. In all cases the objective is to have light emitted towards the walls surrounding the room or to the ceiling, if they are white or off-white, and reflective enough, or towards other reflective surfaces near the lamps, if required by the case. FIGS. 18 and 19 are two views of such a Hubble-Perkin-Elmer correcting mirror for this case of long tubular luminaries. Note that the correcting mirror has a cylindrical symmetry, as required by the luminary symmetry. For the case of a fluorescent luminary installed in a bay above the level of a faux-ceiling, which emits light in all directions around the tube, an extra mirror at least may, and probably should, be placed redirecting to the Hubble-Perkin-Elmer correcting mirror the light emitted upwards, as shown at FIG. 20. In this figure one can see a second reflecting surface Refl_Surf2, above the fluorescent, which has internal reflecting surface (that is, toward the fluorescent tube), which reflects down all the light emitted by the fluorescent tube that misses the Hubble Perkin Elmer correcting mirror below the fluorescent. Such a Refl_Surf2 is only necessary for the newer embedded fluorescents, that are above a faux-ceiling. The older types, much in use after WW II and through the 50s, which sported hanging fluorescents (below the ceiling), perhaps with a frosty glass under it, would not need this second reflecting surface above the fluorescent, because the light emitted upwards would already be directed to the ceiling, from where it reflects to the room below. The second surface Refl_Surf2 may be spherical, semi-spherical, or some other concave shape, though in some cases convex shapes may be useful too.

Other variation is the recessed, indirect light, in which case the light element, either the incandescent filament bulb or tubular fluorescent or any other, is behind a generally light opaque obstruction, near the ceiling, blocking the direct view to the luminary from anywhere in the room. This light opaque obstruction generally has opening upwards and with the lighting elements behind this opaque obstruction which may carry some ornament for decoration and with the light elements sending light in all directions around them. The Hubble-Perkin-Elmer correcting mirror for this type of indirect light around the edges between the ceiling and the upper walls is a set of mirrors with such a curvature as to reflect the light to the ceiling, from where the light suffers a second reflection toward the room, this time an isotropic reflection that causes a pleasing, soft, shadowless illumination.

Another variation of the main embodiment of our invention is to add the possibility of choice of the directions, or orientations, of the Hubble-Perkin-Elmer correcting mirror, which, in turn, change the direction of the reflected light. This variation is useful to avoid reflecting light towards a window or even toward some direction where there exists a dark furniture, or a dark wall, or any other non-desirable direction.

### CONCLUSION, RAMIFICATIONS, AND SCOPE OF INVENTION

There are several other variations and additions to the main embodiment. For example, in the cases of LED substitutes for any of the luminaries, it is possible to put lenses at the front of the LEDs to increase the beam divergence, which ultimately increases the illumination evenness. Such lenses may be either circular or cylindrical, the latter case more adapted to the LED replacement to the tubular fluorescent lamps but works also for even a single LED because it may be the case the it is useful to increase divergence along one direction only, which requires a cylindrical lens. These lenses may be made from plastic molded into the LED case or they may be common lenses added to the device. These lenses may be individual, one for each LED or they may be for more than one LED, or for all the LEDs. These lenses may also be non-isotropic, even if this is a most unusual feature. In this case the anisotropy would be to cause beam divergence for the part of the light that happens to be propagating upwards (where there would be a cylindrical curvature), all the while causing no beam divergence on the part of the light that propagates downwards (where there would be no curvature and therefore no beam spreading). The non-isotropy would be a good feature because it would be advantageous to spread the light beam that is propagating upwards, as long as it is not so spread as to be diverted down, towards possible human eyes, while it would be disadvantageous to spread the light beam that is propagating downwards, because this would redirect some light further downwards, towards human eyes who would be inconvenienced by the bright light. Another possibility would be an even more unusual cylindrical lens one which is so curved as to cause beam divergence on its upper part, causing beam divergence for the upwards propagating light, while its lower part would be so curved as to redirect the incoming light towards the ceiling, to avoid direct bright light into human eyes.

Three cables support Cab the HubblePerkinElmer correcting mirror of our invention, which, for the main embodiment is made of a cone Refl_Cone continued by a truncated cone Refl_Louver, which may be considered a louver. A third and a fourth, etc. truncated cones may exist, and these may be slanted outward from the main vertical axis defined by the E27 female receptacle at the top of the structure (or the E27 inserting screw at the luminary), as seen in the figure, or these may be slanted toward the main vertical axis defined by the E27 luminary support and electrical connector (that is, the surface may slant downward or it may slant upward). The objective of the correcting mirrors is to intercept most of the bright light that would otherwise propagate toward the eyes of people below the luminary, then reflect the bright light toward the upper parts of the walls surrounding the room or to the ceiling above the room, from where the bright light is diffusely reflected to the room, after which no point of origination of light is too bright to cause discomfort on the people in the room. It is worth to repeat here that most light paints used in rooms have a reflectivity of the order of 0.9, so there is a 10% light energy loss in this process, which is an advantage to the former frosty enclosure, which typically has a transmissivity of the order of 0.75 or less, with a 25% or more light energy loss—much larger that the loss associated with the use of the HubblePerkinElmer correcting mirror of our invention.

It is also possible to have fins, or louvers, or shutters below the luminaries and below the Hubble-Perkin-Elmer correcting mirrors, which are positioned in such a manner as to block the light propagation downwards along directions and at such angles with the horizontal to prevent human eyes receiving the direct light beam causing discomfort on them. These louvers should preferentially be mirror-like, redirecting as much as technically possible of the light towards the ceiling or some other reflecting surface, therefore contributing for the total illumination of the room.

It is also possible to have the louvers below the luminaries made from glass without mirroring their first surface (say, not coating the first surface with a metal coating). Such first surfaces would still be good reflectors due to the surface reflectivity as a function of the incidence angle as given by the Fresnel equations. For cases when the incidence angle is close to 90 degrees (grazing angle of incidence) the reflectivity would still be close to 100%, with only a small fraction of the light energy being transmitted through the glass then out of the glass at the second, or lower, surface. This would allow for some light downwards, yet not so bright as to inconvenience people in the room, because most of the light energy would be reflected upwards, toward the upper walls and ceiling, as explained by the Fresnel equations.

Still it is quite possible to have the louvers made from glass with a first surface so treated as to be rough, which spreads both the reflected light and the transmitted light as well. For such a louver with a rough first surface, instead of a reflecting surface, from which light would reflect along many directions upwards and also down along many directions. These louvers may be flat, or they may also be curved of faceted. The louvers may also have a corrugated surface which would reflect the light towards different directions, increasing the evenness of the light distribution in the room. The louvers themselves may be of many shapes, as straight or curved. The louvers may be at the lowest LED, as seen in the figures, but they may be underneath each LED too. Our figures show the louvers at the lowest position only for simplicity but we do not intend to say that this is the only option.

It is also possible to have small swiveling mirrors in front of each LED, or in front of a subset of the LEDs, or in front of part of a legacy luminary (incandescent, fluorescent, etc.), which are capable of redirecting the emitted light into a range of new directions, out from the initial propagation direction. Several possibilities exist, for example, what may be the best option is to have the swiveling mirror occupying the position of a louver below the LED with the swiveling axis at one of the edges of the mirror. This option has the mirror in such a position that in its neutral position the mirror acts as a louver as described above. As the mirror is tilted, it will block more and more of the emitted light, at the same time that it reflects it to larger and larger angles, until finally the mirror is so tilted that it completely blocks the initial light, reflecting all of it to another direction. This other direction may be just a few degrees, if the mirror is long enough, or may be 45 degrees, if the length of the mirror is only equal to sqrt(2)/2 times the beam's diameter d (that is, 0.707*d), in which case beam will block the beam when it is at 45 dgs. It is possible to use smaller mirrors but though this is possible this is not advisable because if the beam is smaller than 0.707*d then the beam would have to go at an angle larger than 45 dgs. and would start redirecting the light backwards, though it is still possible to use such smaller mirrors. The swiveling mirrors also work with old style luminaries, as the E27 incandescent bulbs or with the tubular fluorescents.

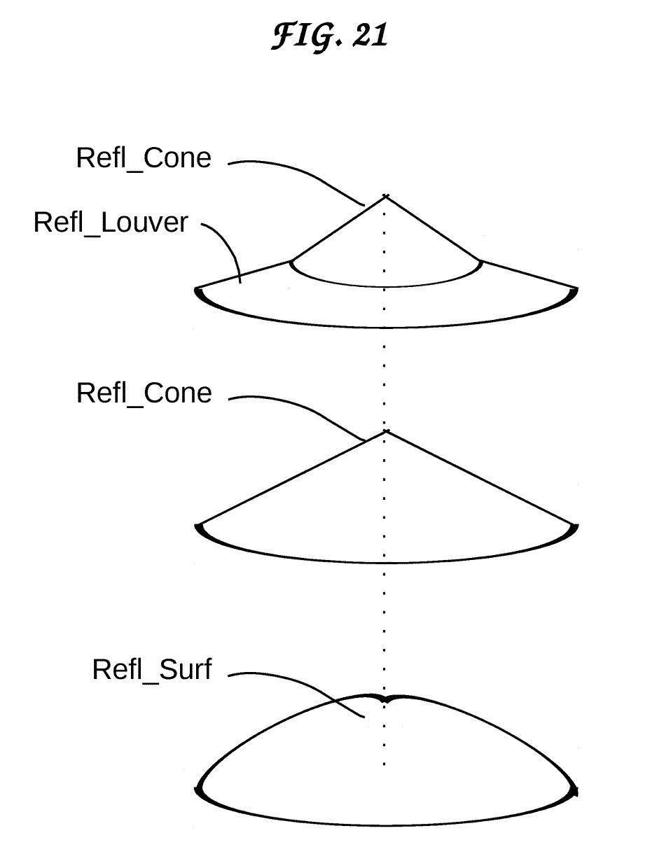

Among the several possible variations of the main embodiment are variations of the shape of the Hubble-Perkin-Elmer correcting mirror, three of which are shown at FIG. 21. It is the intention of the inventors to include all shapes as part of the invention, because they are within the same principle of correcting the propagation direction of the light from the luminary to the upper walls or to the ceiling or to some other convenient location as the case requires.

1. A multi-faceted first reflecting surface for acting in conjunction with a luminary for redirecting a light energy in a room with a ceiling above the room and walls surrounding the room providing directional lighting and configured for electromechanical mechanical connection between to a first tube socket and a second tube socket of a supporting structure lampholder supporting a luminary, mounted in fixed position with respect to the ceiling, the electric light multi-faceted first reflecting surface comprising:
a first surface S_total composed of a plurality of at least one subsurface S_i in fixed position with respect to the luminary,
wherein, in the installed configuration, the first reflecting surface is positioned adjacent to the luminary and so oriented with respect to the luminary and in fixed position with respect to the luminary, such that the first reflecting surface is so oriented with respect to the luminary that reflects at least 25% the light energy originating from the luminary and reflected by the reflecting surface, propagates toward the upper 90% of the walls surrounding the reflecting surface and the room and toward the ceiling.
a light body having a first surface and a second surface, the first surface differing in orientation from the second surface;
an elongated support spanning between the first tube socket and the second tube socket of the lampholder when in an installed configuration, the elongated supporting the light body through a cable; and
a plurality of light emitting diodes mounted on the first surface;
wherein, in the installed configuration, the lampholder is coupled with the elongated support for supporting the light body suspended below the elongated support, such that the first surface with the light emitting diode is oriented toward the lampholder for providing lighting toward the ceiling.

2. The device of claim 1 wherein the supporting structure also supports the luminary.

3. The device of claim 1 wherein the luminary also supports the first reflecting surface in fixed position with respect to the ceiling.

4. The device of claim 1 wherein at least 90% of the light energy originating from the luminary and reflected by the first reflecting surface propagates toward the upper 90% of th walls surrounding the room and toward the ceiling.

5. The device of claim 4 wherein at least 90% of the light energy originating from the luminary and reflected by the first reflecting surface propagates toward the upper 50% of the walls surrounding the room and toward the ceiling.

6. The device of claim 1 with an extra second reflecting surface that is so positioned in the vicinity of the luminary and at such orientation with respect to the luminary and to the first reflecting surface that the light energy emitted by the luminary toward the second reflecting surface is partly redirected to the first reflecting surface.

7. The electric light device of claim 1 wherein a louver extends beyond from the light body beneath the first reflecting surface light emitting diodes to further direct light toward the ceiling above the room and the walls surrounding the room.

8. A method to redirect a light energy from its original direction, the light energy emanating from a luminary, toward points located at upper parts of walls surrounding a room and toward a ceiling above the room, the method comprising:
placing a multi-faceted first reflecting surface for acting in conjunction with the luminary for redirecting the light energy in the room with the walls surrounding the room and the ceiling above the room providing directional lighting and configured for electromechanical mechanical connection between to a first tube socket and a second tube socket of a supporting structure lampholder supporting a luminary, mounted in fixed position with respect to the ceiling, the electric light multi-faceted first reflecting surface comprising:
a surface S_total composed of a plurality of at least one subsurface S_i in fixed position with respect to the luminary,
wherein, in the installed configuration, the first reflecting surface is positioned adjacent to the luminary and so oriented with respect to the luminary and in fixed position with respect to the luminary, such that the reflecting surface is so oriented with respect to the luminary that reflects at least 25% the light energy originating from the luminary and reflected by the reflecting surface, propagates toward the upper 90% of the walls surrounding the reflecting surface and the room and toward the ceiling.

9. The method of claim 8 where the first reflecting surface reflects at least 75% of the light energy originating from the luminary toward the upper 90% of the walls surrounding the room and toward the ceiling.

10. The method of claim 8 where the first reflecting surface reflects at least 25% of the light energy originating from the luminary toward the upper 30% of the walls surrounding the room and toward the ceiling.
